(19) United States
(12) Patent Application Publication
(10) Pub. No.: US 2022/0258830 A1
(43) Pub. Date: Aug. 18, 2022

(54) WHEEL MODULE FOR A VEHICLE, AND VEHICLE COMPRISING SAID WHEEL MODULE

(71) Applicant: Schaeffler Technologies AG & Co. KG, Herzogenaurach (DE)

(72) Inventors: Doris Maria Wimmer, Ottenhöfen (DE); Philippe Wagner, Grosbliederstroff (FR); Simon Ortmann, Baden-Baden (DE); Aurelien Grauss, Mommenheim (FR); Alan Barrera, Karlsruhe (DE)

(73) Assignee: Schaeffler Technologies AG & Co. KG, Herzogenaurach (DE)

(21) Appl. No.: 17/618,605

(22) PCT Filed: May 14, 2020
(86) PCT No.: PCT/DE2020/100418

§ 371 Date: Dec. 13, 2021

(30) Foreign Application Priority Data
Jun. 18, 2019 (DE) 10 2019 116 424.9

(51) Int. Cl. B62L 1/00; B62K 3/00; B62L 3/02; B60B 27/00; F16D 55/02; F16D 65/847; F16D 65/095; F16D 65/18; F16D 69/02

(52) U.S. Cl. CPC B62L 1/005; B62K 3/002; B62L 3/023; B60B 27/0052; F16D 55/02; F16D 2065/785; F16D 65/095; F16D 65/186; F16D 69/02; B62K 2202/00; F16D 65/847

(57) ABSTRACT

A wheel module for a vehicle is disclosed including a wheel, said wheel having a wheel rim; a wheel axle, the wheel rim being rotatably mounted on said wheel axle; and a braking device for braking the wheel, said braking device comprising a brake disc and a brake pad. The brake disc and the brake pad being mutually contactable in order to transmit a braking force F1 to the wheel rim, wherein the brake disc can be axially moved to contact the brake pad and the brake pad remains axially fixed.

### CROSS-REFERENCE TO RELATED APPLICATIONS

This application is the U.S. National Phase of PCT Appin. No. PCT/DE2020100418 filed May 14, 2020, which claims priority to DE 102019116424.9 filed Jun. 18, 2019, the entire disclosures of which are incorporated by reference herein.

### TECHNICAL FIELD

The disclosure relates to a wheel module for a vehicle. Further, the disclosure relates to a vehicle having the wheel module.

### BACKGROUND

It is known to use disc or drum brakes in small, two-wheeled vehicles such as push scooters, scooters or even bicycles, in order to brake a wheel of the small vehicle.

For example, publication DE 200 16 878 U1 describes a push scooter with a braking device in the form of a hydraulically activated disc brake. The braking device comprises a brake disc connected to a wheel in a non-rotatable manner and a brake caliper fixed to the frame of the pedal scooter, wherein the brake caliper contains brake pads acting on the brake disc.

### SUMMARY

It is the object of the disclosure to create a wheel module of the type mentioned above, which is characterized by a compact design. It is also an object of the disclosure to propose a vehicle with the wheel module.

This object is achieved by a wheel module and by a vehicle having the features described herein. Preferred or advantageous embodiments of the disclosure are described in the claims, the following description, and the attached figures.

An object of the disclosure is a wheel module which is designed and/or suitable for a vehicle. In particular, the vehicle is designed as a single or multi-track vehicle. Preferably, the vehicle is designed as an electrically powered vehicle. Preferably, the vehicle is designed as a small or micro vehicle or as an electric vehicle. Preferably, the vehicle has at least one wheel module and/or wheel. With only one wheel module and/or wheel, the vehicle can be configured as an electric unicycle, e.g., as a so-called monowheel or solowheel. With two or more wheel modules and/or wheels, the vehicle is preferably designed as a scooter, in particular as an electric motorcycle, as an electric motor scooter, as an electric pedal scooter, electric scooter, e. g., e-scooter, as a Segway, hoverboard, kickboard, skateboard, longboard or the like. Alternatively, the vehicle can be designed as a bicycle, in particular as an electric bicycle, for example as a pedelec or as an e-bike. The vehicle can alternatively be designed as a multi-track bicycle, in particular with three or more wheels. For example, the vehicle may be a transport or cargo bike, in particular a motorized or electrically powered transport or cargo bike, more specifically a three-wheeled or four-wheeled pedelec or a rickshaw, in particular with or without a roof, or a cabin scooter.

The vehicle can include one or more of the wheel modules. The wheel module has a wheel. In particular, the wheel is a front or rear wheel of the vehicle. The wheel comprises a wheel rim and preferably a tire, the tire being disposed on the wheel rim. Particularly preferably, the tire is an air-filled and/or inflatable rubber tire.

The wheel module has a wheel axle. In particular, the wheel axle is a fixed axle that is firmly connected and/or connectable to a frame or a wheel fork of the vehicle. The wheel rim is rotatably mounted on the wheel axle. In particular, the wheel axle defines an axis of rotation around which the wheel or wheel rim rotates during driving operation. Preferably, at least or exactly one bearing device, preferably exactly two bearing devices, is/are provided for this purpose. Preferably, the at least one bearing device is designed as a rolling bearing.

The wheel module has a braking device which is designed and/or suitable for braking the wheel. In particular, the braking device is designed as a hydraulically actuated braking device. The braking device comprises a brake disc and precisely one brake pad, wherein the brake disc and the brake pad are mutually contactable in order to transmit a braking force to the wheel rim. In particular, when the braking device is actuated, the brake pad and the brake disc are moved relative to each other in the axial direction and brought into frictional and/or force-fitting contact with each other so that a braking torque is transmitted to the wheel. Preferably, the brake disc forms a metallic partner and the brake pad a friction partner. Specifically, the brake disc and brake pad are matched to one another in such a way that the brake pad is subject to greater wear.

Within the scope of the disclosure, it is proposed that the brake pad is connected to the wheel rim in a non-rotatable manner. In particular, the brake pad is arranged on an axial end face of the wheel rim. Preferably, the brake pad is applied directly or indirectly to the wheel rim. In particular, the brake pad covers an outer surface of the wheel rim at least in sections. In principle, the brake pad can be interrupted in the direction of rotation or arranged in several sections on the wheel rim. Particularly preferably, however, the brake pad is designed to be continuous around the circumference.

One advantage of the disclosure is that by arranging the brake pad on the rim, the braking device can be arranged on the wheel in a particularly space-saving manner. The arrangement of the brake pad on the wheel rim also allows the braking device to be adapted in a simple manner to a size of the wheel, in particular to a size of the wheel rim. In particular, the braking device, unlike ordinary brake shoes of a disc brake, builds up only slightly towards the outside, so that any risk of protruding components, which can also heat up, is significantly reduced.

In a preferred embodiment of the disclosure, the brake disc is axially movable to contact the brake pad, with the brake pad remaining axially fixed to the wheel rim. In particular, the brake disc is arranged in a non-rotatable manner in the direction of rotation and displaceable in an axial direction relative to the wheel axle. Particularly preferably, the brake pad rotates about the axis of rotation when the vehicle is in driving operation, wherein the brake disc remains stationary in the direction of rotation. When the braking device is actuated, the brake disc is subjected to a braking force to generate the braking torque and is thus pressed against the brake pad in an axial direction.

It is thus a consideration of the disclosure that due to the axial displacement of the brake disc, only one brake pad is required. Thus, a compact and component-reduced braking device is proposed. In addition, a simple connection to the wheel rim is made possible, especially for small tire diameters.

In another preferred embodiment of the disclosure, the brake pad is designed to be annular in shape and is arranged coaxially and/or concentrically with the wheel rim with respect to the wheel axle. In particular, the brake pad defines an annular surface encircling the axis of rotation, which is arranged coaxially and/or concentrically to the brake disc and/or the wheel rim and/or the wheel axle. Particularly preferably, the brake disc makes flat contact with the annular surface in the actuated state of the braking device.

It is thus a consideration of the disclosure to propose a braking device which is characterized by improved braking performance. The annular design of the brake pad increases the contact area with the brake disc.

In a further preferred implementation, the brake pad forms a thermal insulator so that thermal insulation in the direction of the wheel rim is implemented by the brake pad. In particular, the brake pad reduces heat transfer from the braking device, in particular during a braking process, to the wheel. Preferably, the brake pad is formed from a thermally insulating material. Particularly preferably, the material of the brake pad has a coefficient of thermal conductivity that is significantly smaller than a coefficient of thermal conductivity of the material of the wheel rim. For example, the material of the brake pad has a thermal conductivity coefficient of less than 10 W/(m*K), preferably less than 1 W/(m*K), more specifically less than 0.5 W/(m*K).

Advantageously, the brake pad can significantly reduce heat transfer from the brake pad to the wheel rim, caused by heat generated in particular during braking of the rotating wheel. In particular, damage to the wheel rim and/or components integrated in the wheel, such as bearing devices, wheel drive, etc., can thus be avoided.

It is particularly preferred that the brake pad has a friction means of the “organic” category. In particular, the friction means is made of an organic material. Particularly preferably, the friction means comprises fibers of glass and/or rubber and/or carbon and/or aramid, in particular para-aramid, which are embedded in particular in a resin matrix. Preferably, the resin matrix is formed by a temperature-resistant synthetic or natural resin.

A brake pad is thus proposed which is characterized by a high coefficient of friction and, at the same time, a low coefficient of thermal conductivity or heat transfer.

In a first specification it is provided that the brake pad is applied directly to the wheel rim. In particular, the brake pad is integrated into the wheel rim or applied to the wheel rim, preferably as a coating. Alternatively or optionally in addition, the brake pad is connected to the wheel rim by a material bond. In particular, the brake pad may be bonded to the rim. For example, an adhesive can be used for this purpose which also has thermally insulating properties and/or is mixed with a thermally insulating additive.

It is thus a consideration of the disclosure to propose a brake pad which is characterized by a particularly small axial installation width.

In an alternative specification, it is provided that the braking device has an annular brake pad carrier, which in particular carries the brake pad. The brake pad is fastened and/or can be fastened to the wheel rim via the brake pad carrier, preferably in a force-fitting and/or form-fitting and/or materially bonded manner. Particularly preferably, the brake pad carrier is detachably fastened to the wheel rim, in particular by means of a screw connection. Specifically, the brake pad carrier is attached to the wheel rim by one or more fastening means, such as bolts, rivets, or the like. For example, the brake pad carrier can be made of a material that also has thermal insulating properties and is heat-resistant at the same time. Particularly preferably, the brake pad carrier is arranged coaxially and/or concentrically to the wheel rim and/or the wheel axle.

It is thus a consideration of the disclosure to propose a brake pad which is particularly easy to install on the wheel rim and to remove again. In addition, the suitable choice of brake pad carrier can additionally favor thermal insulation with respect to the wheel rim.

In another preferred embodiment of the disclosure, it is provided that the braking device comprises a concentric brake cylinder which is configured and/or suitable for transmitting a braking force to the brake disc. In particular, the brake cylinder is arranged coaxially and/or concentrically to the wheel axle and/or the brake disc. Preferably, the actuating device is arranged together with the brake pad and the brake disc on one side of the wheel. Particularly preferably, the brake cylinder is designed as a slave cylinder, which is operatively connected via a brake line to a master cylinder, which can be actuated in particular by a brake pedal or brake lever. When the master cylinder is actuated, a fluid column, in particular a hydraulic column, is displaced in the direction of the slave cylinder and converted into a mechanical movement by the brake cylinder.

According to this embodiment, the brake cylinder has an annular housing and an annular piston that is axially displaceable in the annular housing. Preferably, the annular housing has a pressure chamber surrounding the axis of rotation, which is delimited in the axial direction by the annular piston. In particular, the pressure chamber is fluidically connected to the master cylinder. For example, the pressure chamber can be filled with a fluid, in particular a hydraulic fluid. When the braking device is actuated, the annular piston is acted upon by a fluid pressure rising in the pressure chamber, causing the annular piston to displace the brake disc axially in the direction of the brake pad. The annular housing is supported on the wheel axle, in particular in the radial direction, and the annular piston is supported on the brake disc, in particular in the axial direction. In particular, the annular housing can be connected in a form-fitting and/or force-fitting and/or materially bonded manner to the wheel axle at least in the direction of rotation. The annular piston can be supported directly or indirectly, e.g. via a transmission component, on the brake disc. Preferably, the brake disc is arranged axially between the reciprocating piston and the brake pad. Preferably, the brake disc and/or the annular piston and/or the transmission component for introducing the braking torque is connected to the wheel axle and/or the frame and/or the wheel fork of the vehicle in a non-rotatable manner.

It is thus a consideration of the disclosure to propose an actuating device capable of transmitting a uniformly distributed braking force to the brake disc. In addition, the actuating device, which is designed as a concentric brake cylinder, realizes a particularly compact design of the braking device.

In a further preferred embodiment, it is provided that the wheel has a drive device, in particular an electrically operated one, which is designed and/or suitable for driving the wheel. In particular, the drive device is an electrical machine. The drive unit is arranged radially inside the wheel rim or integrated into it. The drive device has a stator that is connected to the wheel axle in a non-rotatable manner and a rotor that is connected to the wheel rim in a non-rotatable manner. In a driving mode, a driving torque is generated by the drive device, which acts on the rotor and thus the wheel, so that the wheel is driven around the axis of rotation. In particular, the brake pad, which is designed as a thermal insulator, protects the drive device from overheating, which can significantly increase the operational reliability and service life of the drive device.

A further object of the disclosure relates to a vehicle having the wheel module as previously described. It is intended that the vehicle is an electric motorcycle or an electric scooter. In particular, the vehicle has exactly one wheel module, the wheel module optionally serving as a front or rear wheel of the vehicle. Preferably, the wheel module is fixed to the wheel fork or frame via the wheel axle. In particular, the wheel fork can be connected to a handlebar of the vehicle so that the wheel module and thus the vehicle can be steered.

### BRIEF DESCRIPTION OF THE DRAWINGS

Further features, advantages and effects of the disclosure are set out in the following description of the preferred embodiments of the disclosure. In the figures:

FIG. 1 shows a three-dimensional representation of a vehicle with a wheel module as an exemplary embodiment of the disclosure;

FIG. 2 shows a schematic sectional view of the wheel module of FIG. 1 as a further exemplary embodiment of the disclosure.

### DETAILED DESCRIPTION

Parts that correspond to each other or are identical are marked with the same reference numbers in the figures.

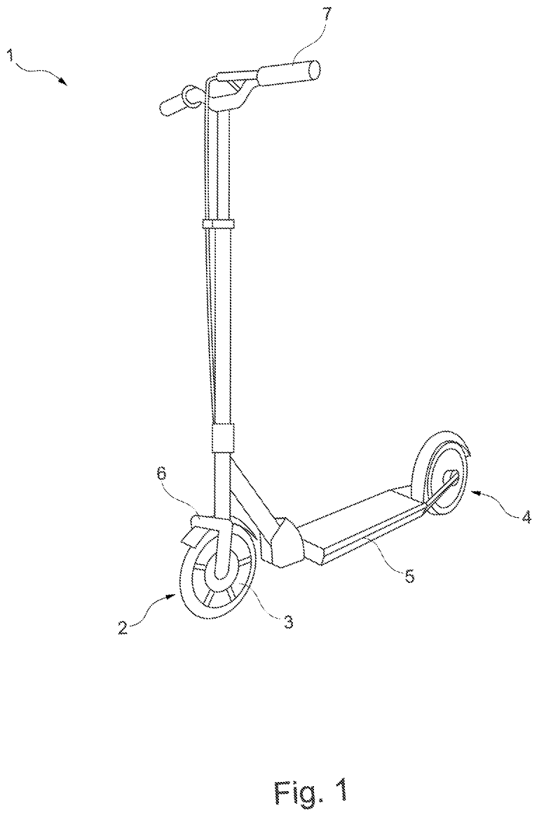

FIG. 1 shows a three-dimensional representation of a vehicle 1, wherein the vehicle 1 is designed as an electric motorcycle, electric pedal scooter or electric scooter, also known as an e-scooter. The vehicle 1 has a wheel module 2 with a wheel 3, which forms a front wheel of the vehicle 1. The wheel module 2 is used in particular to electrically drive the vehicle 1. In addition, the vehicle 1 has a rear wheel 4, in particular a non-powered rear wheel, which is rotatably mounted on a vehicle frame 5 of the vehicle 1.

The vehicle 1 has a wheel fork 6, wherein the wheel module 2 is rotatably mounted in the wheel fork 6. The wheel fork 6 is pivotally connected to the frame 5 via handlebars 7, so that the wheel module 2 can be pivoted via the handlebars 7 to steer the vehicle 1.

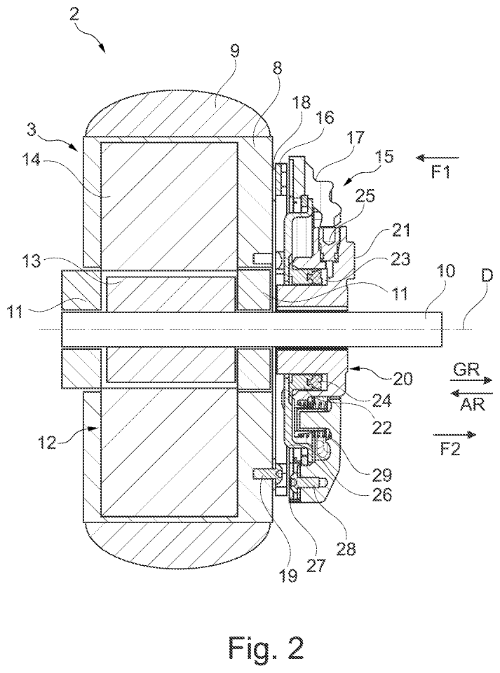

FIG. 2 shows a schematic sectional view of the wheel module 2 of FIG. 1 as an exemplary embodiment of the disclosure. The wheel 3 of the wheel module 2 has a wheel rim 8 and a tire 9, the tire 9 being arranged on the wheel rim 8. For example, the wheel rim 8 is designed as a steel, aluminum or plastic rim. For example, the tire 9 is designed as a rubber tire filled with air.

The wheel module 3 has a wheel axle 10, which defines an axis of rotation D with its longitudinal axis. The wheel 3 is arranged coaxially to the axis of rotation D on the wheel axle 10. The wheel axle 10 is fixed to the wheel fork 6, wherein the wheel rim 8 is rotatably mounted on the wheel axle 10 via two bearing devices 11, e.g., rolling bearings.

To drive the wheel 3, the wheel module 2 has a drive device 12, for example an electric motor, integrated into the wheel rim 8. The drive device 12 has a stator 13 connected to the wheel axle 10 in a non-rotatable manner, which is arranged between the two bearing devices 11 in the axial direction with respect to the axis of rotation D. In addition, the drive device 12 has a rotor 14 that is connected to the wheel rim 8 in a non-rotatable manner. In driving operation of the vehicle 1, a driving torque is generated between the stator 13 and the rotor 14, so that the wheel rim 11 is driven by the drive device 12 and the wheel 3 rotates around the axis of rotation D.

The wheel module 1 has a braking device 15, which is used to transmit a braking torque to the wheel 3. The braking device 15 is designed as a friction brake and is arranged on one side of the wheel rim 8 and/or is operatively connected to the wheel rim 8.

The braking device 15 has an annular brake pad 16, in particular one encircling the axis of rotation D, and a brake disc 17, wherein the brake pad 16 and the brake disc 17 are arranged coaxially with respect to the axis of rotation D. The brake pad 16 is mounted in a non-rotatable manner with respect to the axis of rotation D on an axial end face of the wheel rim 8, so that the brake pad 16 is carried along by the wheel rim 8 during driving operation and rotates about the axis of rotation D. The brake disc 17 is movable in an axial direction AR towards the brake pad 16 and in an axial opposite direction GR away from the brake pad 16. In the direction of rotation about the axis of rotation D, the brake disc 17 is coupled to the wheel axle 10 in a non-rotatable manner.

The braking device 15 has a brake pad carrier 18, which carries the brake pad 16 on the wheel rim 8. For example, the brake pad 9 is materially bonded to the brake pad carrier 10. The brake pad carrier 19 is annular in shape, e.g., in the form of a sheet metal ring, and is fastened to the wheel rim 2 by fastening means 19, in particular by a plurality of screws. The brake pad carrier 19 is arranged on the wheel rim 8 in such a way that it is coaxial and/or concentric with the wheel rim 8.

Further, the braking device 15 includes a concentric brake cylinder 20 for transferring a braking force F1 to the brake disc 17. The brake cylinder 20 can be actuated hydraulically, for example, wherein the brake cylinder 20 is designed as a so-called slave cylinder for this purpose and is fluidically connected to a master cylinder, not shown, via a hydraulic line.

The brake cylinder 20 has an annular housing 21 and an annular piston 22, wherein the annular piston 22 is received in the annular housing 21 in an axially displaceable manner. The annular housing 21 is mounted on the wheel axle 10 and can be connected to the wheel axle 10 in a non-rotatable manner, for example, by means of a spline or an interference fit. The annular housing 21 has a pressure chamber 23 surrounding the axis of rotation D, which is filled with a fluid, for example with a hydraulic oil. The pressure chamber 23 is delimited in the axial direction AR by the annular piston 22 and sealed by a sealing means 24, e.g. a grooved sealing ring, arranged on the annular piston 22. In addition, the annular housing 21 has a radially inserted hydraulic connection 25, in particular a brake line, for connecting the master cylinder.

The braking device 15 has a transmission component 26 for transmitting the braking force F1 from the annular piston 22 to the brake disc 17. The transmission component 26 is designed as an annular disc arranged coaxially to the axis of rotation D, wherein the annular piston 22 is supported in the axial direction AR on an inner diameter and the brake disc is supported in the axial opposite direction GR on an outer diameter of the transmission component 26. For this purpose, the brake disc 17 is designed to be annular in shape and arranged coaxially and/or concentrically with respect to the axis of rotation D relative to the transmission component 26 and/or the brake cylinder 20.

In the exemplary embodiment shown, the braking device 15 additionally has an annular contact plate 27, for example a steel plate, which is arranged on an axial end face of the brake disc 17. The contact plate 27 is used to make contact with the brake pad 16 and, as a wear part, can be replaced in a simple manner. For this purpose, the contact plate 27 is detachably connected to the brake disc 17 via a plurality of securing means 28.

When the braking device 15 is actuated, a fluid column is displaced from the master cylinder toward the brake cylinder 20, wherein fluid flows into the pressure chamber 23 through the hydraulic connection and fluid pressure is applied to the annular piston 22. The annular piston 22 then performs a stroke in the axial direction AR and transmits the braking force F1 generated by the fluid pressure to the brake disc 17 via the transmission component 26. This causes the brake disc 17 to be displaced axially in the direction of the wheel rim 8, to be applied to and/or pressed against the brake pad 16.

In the actuated state of the braking device 15, the brake disc 17 contacts the brake pad 16 so that the braking torque is formed by a frictional connection to brake the rotating wheel 3 by friction between the brake disc 17 and the brake pad 16. During heavy braking, high temperatures develop, especially at the brake pad 16, which can lead to overheating of the drive device 12. In addition, the service life may decrease as the materials in the drive device 12 age more quickly at high temperatures.

In this regard, it is provided that the brake pad 16 and/or the brake pad carrier 18 are formed as a thermal insulator to insulate the wheel rim 8, and thus the drive device 12, from incident heat generated by brake friction. For this purpose, the brake pad 16 may, for example, comprise a friction means made of an organic material, such as glass, rubber or carbon fibers.

When the braking device 15 is released, the fluid column is displaced again in the direction of the master cylinder so that the brake disc 17 is moved or is movable away from the brake pad 16 in the axial opposite direction GR. The braking device 15 has a plurality of return springs 29 distributed in the circumferential direction, which apply a return force F2 to the brake disc 17 and thus to the annular piston 22 in the axial opposite direction GR. The return springs 29 are supported in each case in the axial direction AR on the annular housing 21 and in the axial opposite direction GR on the brake disc 17.

Because the brake pad 16 and/or the brake pad carrier 18 is/are arranged on the wheel rim 8, the braking device 15 can advantageously be designed to be particularly space-saving and particularly slim and narrow. Moreover, due to the concentric design of the braking device 15, the braking device 15 can be adapted in a simple manner to a size of the wheel 3, in particular to a size of the wheel rim 8.

### LIST OF REFERENCE NUMBERS

1 Vehicle
2 Wheel module
3 Wheel
4 Rear wheel
5 Frame
6 Wheel fork
7 Handlebars
8 Wheel rim
9 Tires
10 Wheel axle
11 Bearing devices
12 Drive device
13 Stator
14 Rotor
15 Braking device
16 Brake pad
17 Brake disc
18 Brake pad carrier
19 Fastening means
20 Brake cylinder
21 Annular housing
22 Annular piston
23 Pressure chamber
24 Sealing means
25 Hydraulic connection
26 Transmission component
27 Contact plate
28 Securing means
29 Return springs
D Axis of rotation
AR Axial direction
GR Axial opposite direction
F1 Braking force
F2 Return force

1. A wheel module for a vehicle, comprising:
a wheel, said wheel having a wheel rim,
a wheel axle, the wheel rim being rotatably mounted on the wheel axle, and
a braking device for braking the wheel, said braking device comprising a brake disc and a brake pad, said brake disc and said brake pad being mutually contactable in order to transmit a braking force to the wheel rim,
wherein the brake pad is connected to the wheel in a non-rotatable manner.

2. The wheel module according to claim 1, wherein the brake disc can be axially moved to contact the brake pad, the brake pad remaining axially fixed to the wheel rim.

3. The wheel module according to claim 1, wherein the brake pad is annular in design, the brake pad being arranged coaxially concentrically to the wheel rim.

4. The wheel module according to claim 1, wherein the brake pad forms a thermal insulator so that thermal insulation in a direction of the wheel rim is implemented by the brake pad.

5. The wheel module according to claim 4, wherein the brake has a friction means of made of an organic material.

6. The wheel module according to claim 1, wherein the brake pad is applied directly to the wheel rim or is connected to the wheel rim by a material bond.

7. The wheel module according to claim 1, wherein the braking device comprises an annular brake pad carrier, the brake pad being attached to the wheel rim via the brake pad carrier.

8. The wheel module according to claim 1, wherein the braking device has a concentric brake cylinder for transferring the braking force to the brake disc, the brake cylinder having an annular housing arranged coaxially with the wheel axle and an annular piston axially displaceable in the annular housing, the annular housing being supported on the wheel axle and the annular piston being supported on the brake disc.

9. The wheel module according to claim 1, wherein the wheel has a drive device for driving the wheel, the drive device being arranged radially inside the wheel rim and the drive device having a stator connected in a non-rotatable manner to the wheel axle and a rotor connected in a non-rotatable manner to the wheel rim.

10. A vehicle with the wheel module according to claim 1, wherein the vehicle is an electric motorcycle or an electric scooter.

11. A wheel module for a vehicle, comprising:
a wheel having a wheel rim;
a wheel axle, the wheel rim being rotatably mounted on the wheel axle; and
a braking device configured for braking the wheel and comprising a brake disc and a brake pad, wherein the brake pad is axially fixed to the wheel rim in a non-rotatable manner and the brake disc is configured to be axially movable to contact the brake pad to transmit a braking force to the wheel rim.

12. The wheel module according to claim 11, wherein the braking device further comprises an annular contact plate arranged on an axial end face of the brake disc, wherein the annular contact plate is configured to contact the brake pad to transmit the braking force.

13. The wheel module according to claim 11, wherein the wheel rim is rotatably mounted on the wheel axle via two bearings.

14. The wheel module according to claim 13, further comprising a drive device including a rotor connected to the wheel rim in a non-rotatable manner and a stator connected to the wheel axle in a non-rotatable manner, wherein the stator is arranged axially between the two bearings.

15. The wheel module according to claim 11, wherein the braking device further comprises a brake pad carrier fixed to the wheel rim, wherein the brake pad is materially bonded to the brake pad carrier.

16. The wheel module according to claim 11, wherein the braking device further comprises:
a concentric brake cylinder configured for transferring the braking force to the brake disc, the brake cylinder having an annular housing arranged coaxially with the wheel axle; and
an annular piston configured to be axially displaceable that is received within the annular housing and supported on the brake disc.

17. The wheel module according to claim 16, wherein the braking device further comprises a transmission component configured for transmitting the braking force from the annular piston to the brake disc, wherein the annular piston is supported in a first axial direction on an inner diameter of the transmission component and the brake disc is supported in a second axial direction, opposite the first axial direction, on an outer diameter of the transmission component.
